(19) United States
(12) Patent Application Publication
(10) Pub. No.: US 2019/0340685 A1
(43) Pub. Date: Nov. 7, 2019

(54) BLOCKCHAIN-BASED ASSET AND IMMUTABLE REAL-TIME INTELLIGENT SECURITIES PLATFORM

(71) Applicant: Alpha Ledger Technologies, Inc., Kingston, WA (US)

(72) Inventors: Chris Wade, Kingston, WA (US); Manish Dutta, Corona Del Mar, CA (US)

(21) Appl. No.: 15/969,913

(22) Filed: May 3, 2018

(51) Int. Cl. G06Q 40/04; G06Q 20/06

(52) U.S. Cl. CPC G06Q 40/04; G06Q 20/0655

(57) ABSTRACT

A system for blockchain-based asset and securities management is provided, comprising a registration service configured to provide an interface for a user to register a commodity and input additional information pertaining to the, and generate an ownership token associated with at least the commodity; a smart contract configured to generate a smart contract based on at least the commodity; and a connector service configured to register the commodity with a regulatory agency; wherein at least a portion of the records are stored and propagated on a blockchain.

### CROSS-REFERENCE TO RELATED APPLICATIONS

None

### BACKGROUND OF THE INVENTION

### Field of the Invention

The disclosure relates to the field of blockchain technology, particularly to the management of assets and securities using blockchain technology.

### Discussion of the State of the Art

Recently, blockchain-based cryptocurrencies, such as BITCOIN, ETHEREUM, and RIPPLE, have made numerous headlines at various news outlets. Although the news mainly pertained to its increasing value to new all-time highs, the technology behind these cryptocurrencies, the blockchain, cannot be ignored. For example, ETHEREUM is a blockchain-based platform in which developers can develop and release distributed applications (dapps), which today includes games, ways to donate to charity, and casinos. There are over one thousand dapps available to the public.

One field that remains skeptical of blockchain-based technologies, despite all the benefits, is the investment industry, particular issuing of bonds by governments or companies. Benefits may include, but is not limited to, increased participation due to more exposure, faster transaction settlement times (same day as opposed to two business days), and lower fees. Industry skepticism may be not only due to the extreme volatility of value of cryptocurrencies, which is a widely accepted trait regarding cryptocurrencies available in the art today; but it may also be due to a lack of accessibility when compared to credit card or cash transactions. For example, some blockchain-based platforms allow for creation of “smart contracts” that may be programmed to automate numerous tasks, which may be useful to automate loan repayments or even in collection of fees (and many other applications outside of investment), however, this requires programming experience to create, for example SOLIDITY is used to create smart contracts on the ETHEREUM platform.

What is needed is a system which is user-friendly and accessible, even to newcomers. Accessibility should include creating user-friendly creation of smart contracts, and exchanging fiat for digital certificates represented by Immutable Real-time Intelligent Security (IRIS) Tokens to use on a particular platform and also when withdrawing back to fiat. Also, value volatility of such a system should be comparable to standard, widely-used currencies in order to increase participant confidence and trust in such a system.

### SUMMARY OF THE INVENTION

Accordingly, the inventor has conceived, and reduced to practice, a blockchain-based asset and immutable real-time intelligent securities platform.

In a preferred embodiment, a platform is provided that allows users to register assets, trades assets, create or participate in investment opportunities, and the like using a variety of tokens that may be backed by fiat such as, but is not limited to, debt obligations, certificate of deposits, and other tangible goods in order to decrease volatility in distributed token value. Management and control of assets and investments may be automated by one or more smart contracts that may be created using a user-friendly interface to automatically execute preprogrammed tasks when one or more conditions are met. All data, including transaction history, investments, assets, and smart contracts, are stored on a persistent distributed digital ledger known in the art as a blockchain, which may be available for public inspection. The transparency and immutable nature associated with the blockchain may also allow for transactions to be confirmed in much less time than conventional banking methods, and offer inherent notarization of all transactions.

In an aspect of the invention, a system for blockchain-based asset and securities management is provided, comprising a registration service comprising a memory, a processor, and a plurality of programming instructions stored in the memory thereof and operable on the processor thereof, wherein the programmable instructions, when operating on the processor, cause the processor to provide an interface for a user to register a commodity and input additional information pertaining to the commodity including at least a category for the commodity, and generate an ownership token associated with at least the commodity; a smart contract generator comprising a memory, a processor, and a plurality of programming instructions stored in the memory thereof and operable on the processor thereof, wherein the programmable instructions, when operating on the processor, cause the processor to generate a smart contract based on at least the commodity, the ownership token, and the additional information; and a connector service comprising a memory, a processor, and a plurality of programming instructions stored in the memory thereof and operable on the processor thereof, wherein the programmable instructions, when operating on the processor, cause the processor to register the commodity with a regulatory agency based at least on the category for the issuance; wherein at least a portion of records pertaining to the registering of the commodity, the smart contract, and the ownership token are stored and propagated on a blockchain.

In another embodiment of the invention, the system further comprises a user verification service comprising a memory, a processor, and a plurality of programming instructions stored in the memory thereof and operable on the processor thereof, wherein the programmable instructions, when operating on the processor, cause the processor to automatically verify the identity of the user by at least using a “know your customer” process wherein background information of a user is checked. In another embodiment of the invention, the system further comprises a settlement engine comprising a memory, a processor, and a plurality of programming instructions stored in the memory thereof and operable on the processor thereof, wherein the programmable instructions, when operating on the processor, cause the processor to monitor the blockchain for a consensus to be reached before executing a user request. In another embodiment of the invention, the system further comprises a marketplace front-end comprising a memory, a processor, and a plurality of programming instructions stored in the memory thereof and operable on the processor thereof, wherein the programmable instructions, when operating on the processor, cause the processor to provide an interface to facilitate the exchange of goods and services between a plurality of users. In another embodiment of the invention, the registered commodity results in a bond-issuing smart contract, and the additional information further comprises contractual terms for issued bonds. In another embodiment of the invention, the registered commodity results in a certificate-of-deposit-issuing smart contract, and the additional information further comprises contractual terms for issued certificate of deposits. In another embodiment of the invention, the registered commodity are crops. In another embodiment of the invention, the registered commodity are manufactured articles.

In another aspect of the invention, a method for blockchain-based asset and securities management, comprising the steps of: (a) providing an interface for a user to register a commodity and input additional information pertaining to the commodity including at least a category for the commodity, using a registration service; (b) generating an ownership token associated with at least the commodity, using the registration service; (c) generating a smart contract based on at least the commodity, the ownership token, and the additional information, using a smart contract generator; (d) registering the commodity with a regulatory agency based at least on the category for the issuance, using a connector service; and (e) storing at least a portion of records pertaining to the registering of the commodity, the smart contract, and the ownership token are stored and propagated on a blockchain.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is an illustration of an exemplary platform for asset and investment management using a blockchain according to various embodiments of the invention.

FIG. 1A is a block diagram illustrating several key functions of a regulation service in regards to Know-Your-Customer practices and controls for the purpose of buying and trading bonds and securities tokens.

FIG. 2 is a block diagram of an exemplary system employing the platform illustrated in FIG. 1 according to one aspect of the invention.

FIG. 3 (Prior Art) is a flow diagram illustrating an exemplary method for issuing bonds in the prior art.

FIG. 4 (Prior Art) is a flow diagram illustrating an exemplary method for bond trading in a secondary market in the prior art.

FIG. 5 is a block diagram of an exemplary system showing a typical layout and involvement of various entities in bond issuance according to various embodiments of the invention.

FIG. 6 is a flow diagram illustrating an exemplary method for an issuer issuing bonds using the platform illustrated in FIG. 1 according to various embodiments of the invention.

FIG. 7 is a flow diagram illustrating an exemplary method for a bond purchase transaction using the platform illustrated in FIG. 1 according to various embodiments of the invention.

FIG. 8 is a flow diagram illustrating an exemplary method for exchanging currency tokens for a bank-issued certificate of deposits using the platform illustrated in FIG. 1 according to various embodiments of the invention.

FIG. 9 is a flow diagram illustrating an exemplary method for a general transaction using the platform illustrated in FIG. 1 according to various embodiments of the invention.

FIG. 10 is a flow diagram illustrating an exemplary method for production tracking according to various embodiments of the invention.

FIG. 11 is a flow diagram illustrating an exemplary method for a manufacturer registering a product using the platform illustrated in FIG. 1 according to various embodiments of the invention.

FIG. 12 is a flow diagram illustrating an exemplary method for transferring a product token using the platform illustrated in FIG. 1 according to various embodiments of the invention.

FIG. 13 is a block diagram illustrating an exemplary hardware architecture of a computing device used in various embodiments of the invention.

FIG. 14 is a block diagram illustrating an exemplary logical architecture for a client device, according to various embodiments of the invention.

FIG. 15 is a block diagram illustrating an exemplary architectural arrangement of clients, servers, and external services, according to various embodiments of the invention.

FIG. 16 is another block diagram illustrating an exemplary hardware architecture of a computing device used in various embodiments of the invention.

### DETAILED DESCRIPTION

The inventor has conceived, and reduced to practice, a blockchain-based asset and immutable real-time intelligent securities platform.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, a “blockchain” is a digital and decentralized ledger stored on non-volatile memory of distributed computer systems known as nodes. A blockchain may comprise a series of immutable “blocks” of data that are added to the blockchain after being verified by a predetermined number of node systems (or a when consensus is reached), which are verified using a process such as “proof of work” (verified by nodes through the use of computational power) or “proof of stake” (verified by users who hold a “stake” of a particular currency associated with a blockchain). Since the blocks are added as transactions occur, the blocks on a blockchain are, consequently, chronologically ordered. The information contained on a blockchain may also be accessible to selected regulatory agencies, as to provide transparency for the transactions that are recorded on the blockchain.

As used herein, a “token” is a unit of currency, particular asset, or utility used throughout a particular blockchain. A single blockchain may utilize a plurality of different tokens simultaneously for different purposes. One example in the art for a blockchain implementation that utilizes a number of tokens, many of which are created by independent developers, is ETHEREUM and the many distributed applications (dapps) built upon the ETHEREUM platform. For the purposes of this disclosure, a “currency token” will be used to denote a basic unit of currency used for the present invention.

As used herein, a “smart contract” is a digital contract created using a computer language, for example SOLIDITY or C-SHARP, that may specify conditions to fulfill in order to execute certain transactions. A simple example would be to send a preset number of currency tokens to a preset account every time period, however, smart contracts may be created perform more complex functions, such as creation of child smart contracts or even serve as applications stored on a blockchain.

### Conceptual Architecture

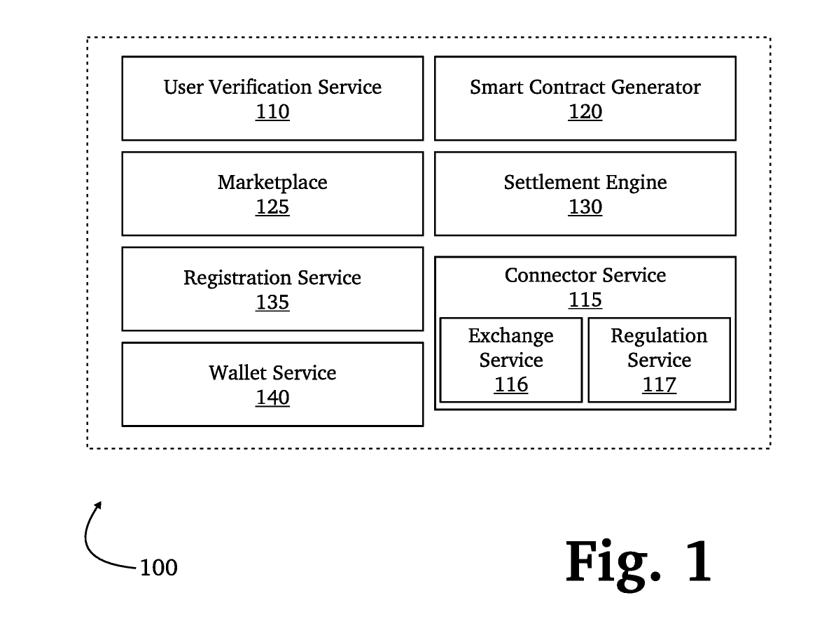

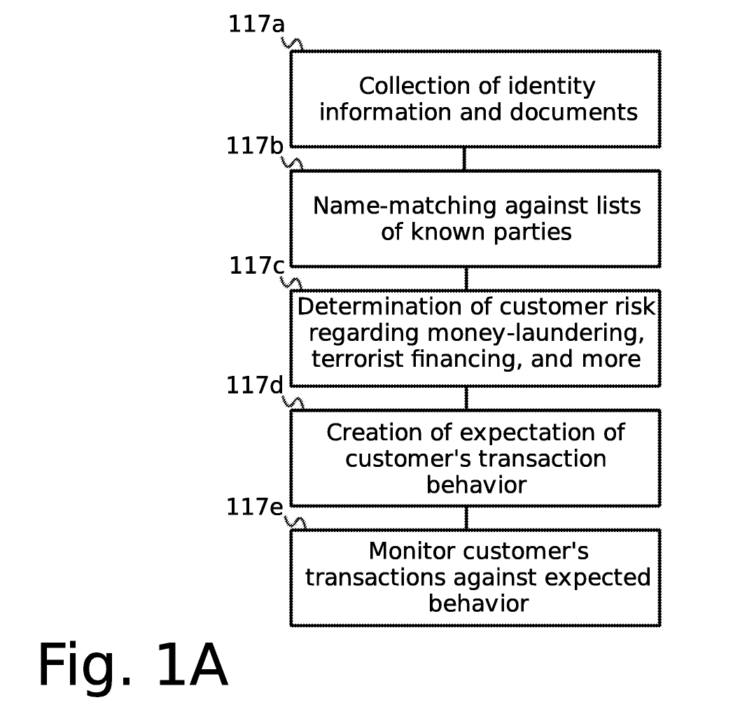

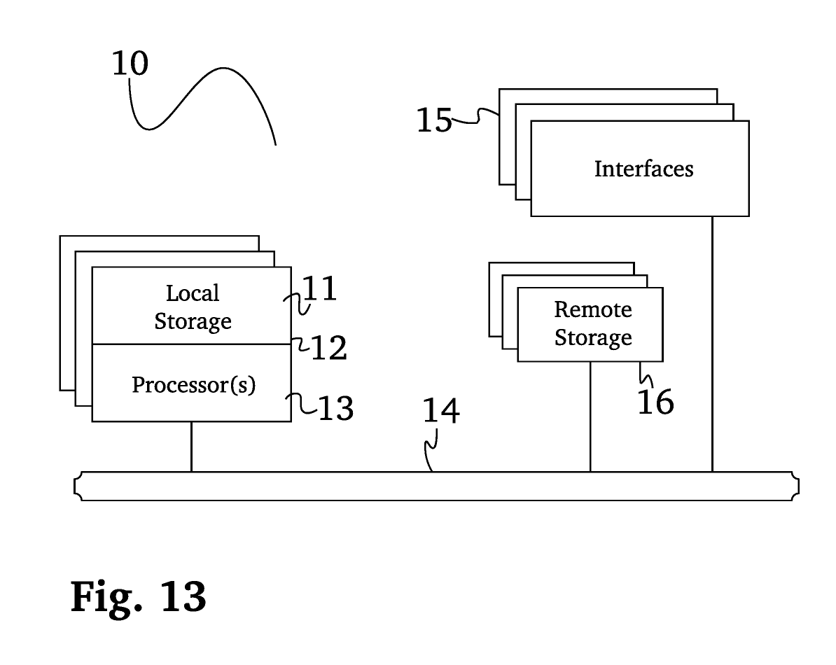

FIG. 1 is an illustration of an exemplary platform 100 for asset and securities management using a blockchain according to various embodiments of the invention. Platform 100 may be configured to operate on a processor, for example, a processor on a system as shown below in FIG. 13, 14, or 16. Platform 100 aims to decrease volatility, which is often associated with cryptocurrencies existing in the art, by backing distributed currency tokens with fiat, issued debt, certificate of deposits (CD), and the like that has a tangible monetary value. Consequently, this may necessitate a finite number of currency tokens to be distributed, and currency tokens may be destroyed when a user initiates a withdraw from the system in order to maintain the value of currency tokens. In some embodiments, currency tokens may not be used at all, and transactions may, instead, involve the exchange of fiat automatically acquired from a user's linked bank account. For the purposes of this disclosure, currency tokens will be used to differentiate from the various token types disclosed herein. Platform 100 may comprise a user verification service 110, a connector service 115, a smart contract generator 120, a marketplace front-end 125, a settlement engine 130, a registration service 135, and a wallet service 140.

Verification service 110 may be configured to identify and verify a user's identity before any transactions are allowed to be executed. Verification service 110 may use, for example, a Know Your Customer (KYC) process commonly used by financial institutions in the art to identify and vet clients to reduce the risk of funds going to, for example, terrorism purposes or money laundering, in accordance with several laws and practices in the art such as the Bank Secrecy Act of 1970. In some embodiments, the KYC process may be administered by an accredited regulatory entity that may have the authority to approve and essentially sign a user's digital identity intended for use with platform 100, allowing for compliance with the General Data Protection Regulation and other data regulation compliance requirements in various legal bodies. This may be accomplished, for example, by granting the wallet an untradeable verification token distributed by the accredited regulatory entity. Other authentication methods may be additionally used, for example, possession of a private encryption key; unique, one-time-use alphanumeric code; a user-created password; and the like, some of which may be commonplace and known to one possessing ordinary skill in the art.

Connector service 115 may be configured to facilitate communications with external institutions, and automate functions, for example, connecting to banks and credit card providers to exchange fiat or credit for currency tokens, and vice versa, with an exchange service 116; connecting to appropriate regulatory agencies to register particular assets or securities using a regulation service 117; and the like. For example, a user making a transaction to purchase a bond in the marketplace may have the appropriate amount of funds automatically withdrawn and exchanged for currency tokens to purchase the bond; a car manufacturer may register manufactured cars with platform 100, which may then register the car with the United States Department of Transportation; or registration of issuing securities may be registered with the United States Securities and Exchange Commission.

Smart contract generator 120 may be configured to compile term sheets, contractual terms, and other obligations into a smart contract. This may allow, for instance, automated repayments for a bondholder smart contract, automated fee collection for a vehicle owner smart contract, and the like. Smart contract generator 120 may include an intuitive front-end for issuers to generate an issuing smart contract without extensive programming experience. For example, an issuer may be presented with an interface to allow the issuer to pick from a number of options such as term length, interest rates, issuing limits, and the like and smart contract generator 120 will generate the required code for the issuing smart contract. Smart contract generator 120 may also be configured to accept and process formatted term sheets and generate a smart contract.

Marketplace 125 may be a front-end that allows users to browse for investment opportunities, exchange currency tokens for good and services from other users, browse a repo market, trade securities like bonds or other debt instruments or CD's directly with other users, and the like without requiring users to go through a broker or brokerage house. Issuers may have their investment listings posted to the marketplace automatically once the issuer completes registration, and an issuing smart contract has been successfully generated.

Settlement engine 130 may be configured to verify transactions before initiating an exchange. This may be achieved by, for example, monitoring nodes for confirmations and executes a transaction only once a consensus is reached amongst a pre-determined number of nodes. Settlement engine 130 may also be configured to timestamp successful transactions before the transaction is stored to the blockchain.

Registration service 135 may be configured to allow businesses and organizations to register with platform 100. Registration may entail registering to issue bonds by organizations for funding purposes, registering to issue certificate of deposits by a back, registering products by a manufacturer, registering to issue contract for goods and services, and the like. Certain assets and products may generate a token during registration may be used to signify ownership of the associated product. For example, a farmer may register a crop to get a crop token to register the crop on the blockchain in order to track the crop; a car manufacturer may register a vehicle to generate a vehicle token that may be held by the owner of the vehicle signify ownership; or an organization may register to issue bonds, and be provided with an issuer token to represent ownership of the debt obligation. A smart contract, also generated during the registration process, may then be configured to interact with the token holder, for example, paying interest to a bond token holder, or automatically collecting registration fees from a holder of a token for a vehicle.

Wallet service 140 may be configured to monitor transactions on the blockchain and maintains balances in a wallet for users of platform 100. Transactions that may change the balance of a particular wallet may include, for example, exchanging of fiat for currency tokens, exchange between marketplace participants, direct sending or receiving of tokens, and the like. Since platform 100 stores and handles assets and securities as tokens, wallets may also store these assets and tokens. Wallets may also be configured to store identification information of the owner, for example, successful verification through a KYC process, digitized signature, and the like.

FIG. 1A is a block diagram illustrating several key functions of a regulation service 117 in regards to Know-Your-Customer practices and controls for the purpose of buying and trading bonds and securities tokens. Using a regulation service 117, for the trading of bonds and securities, customer and security compliance may be ensured using common Know-Your-Customer (KYC) controls including the collection of basic user identity information 117a upon registration with the system in tandem with a verification service 110. Another key function would be matching a user's name against a list of names for various checks including possible criminals and politically-exposed persons which may be of interest 117b, a preliminary determination of customer risk regarding money-laundering, financing terrorist organizations or individuals, and more 117c, through the use of customer information and lookups of ancillary information online. A further step to take for KYC controls would be the creation of a profile of expected transaction behavior from a user 117d, based on collected information from a user, including their age, personal financial history as collected by the platform 100, and information gathered from previous KYC controls. Another step, according to a preferred aspect, for KYC security checks would be to then monitor a user's transactions through the system over time, in comparison to expected transaction behavior 117e, in which a user deviating significantly and abruptly from expected and previously demonstrated behavior may be cause for investigation, for example a user suddenly buying and trading stocks in a rapid fashion and in large amounts compared to previous data and against known financial information of said user.

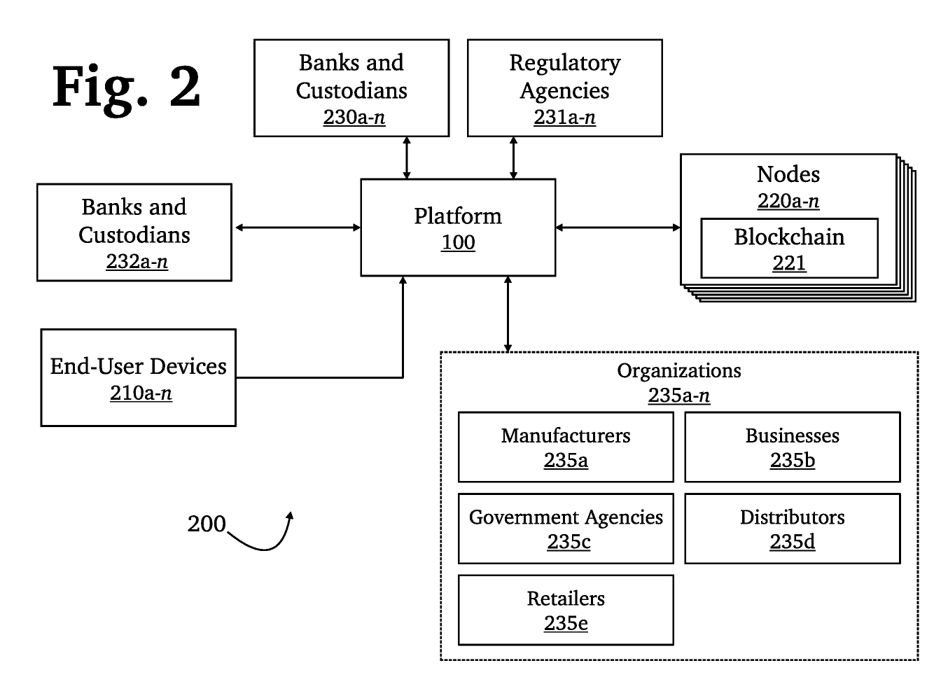

FIG. 2 is a block diagram of an exemplary system 200 employing platform 100 according to one aspect of the invention. System 200 may comprise a plurality of end-user devices 210a-n, a plurality of nodes 220a-n, a plurality of banks 230a-n, a plurality of regulatory agencies 231A-n, a plurality of custodians 232a-n, and a plurality of organizations 235a-n. User devices 210a-n may be any internet-connected device used in the art, including smartphones, laptops, desktops, tablets, and the like that users may use to access platform 100. Users may also use the devices to access their wallet, and use the device for transactions made at a physical point of sales. For example, a user may use a mobile device equipped with near-field communication capabilities to spend funds held in their wallet.

Nodes 220a-n may be any internet-connected device used in the art, including smartphones, laptops, desktops, tablets, and the like that may be used to host an instance of a blockchain 221, in which history of all data and transactions may be stored and synced across all nodes.

Banks 230a-n may be any financial institution in which users may have their money stored, or may have a line of credit with. Platform 100 may connect to banks 230a-n to exchange fiat for IRIS tokens to execute transactions on the platform, and also converting tokens back into fiat. When processing tokens, banks 230a-n may involve an additional step of verifying tokens to ensure that they are legitimate. An Immutable Real-time Intelligent Security (IRIS) token in this context is represented by a blockchain 221 entry which provides security and immutability after initialization, with future transactions being recorded as new entries on the blockchain 221.

Regulatory agencies 231A-n may be agencies that oversees and regulates certain industries, for example, issuing of bonds, manufacturing of street-legal vehicles, firearms, cannabis, and the like. When a manufacturer registers a product using platform 100, registration with the appropriate regulatory agency may occur automatically. Regulatory agencies may be involved in the distribution or lack thereof of data regarding the platform 100 and any users or particular blockchains 221 for compliance with laws and regulations including the General Data Protection Regulation in the European Union, anti-money laundering laws and practices including the Bank Secrecy Act of 1970, and more, combined with user verification processes 110 which may include informing regulatory agencies of specific user registrations or transactions as required by any laws or regulations in areas of operation.

Custodians 232a-n may be any financial institution responsible for safeguarding financial assets of users of platform 100.

Organizations 235a-n may be any organization that utilizes platform 100 to acquire funding, track goods, issue contracts, and the like. Some examples of organization may include, but is not limited to, manufacturers 235a, businesses (both large and small) 235b, government agencies (including local governments) 235c, distributers 235d, and retailers 235e.

It should be understood that although platform 100 is shown as a singular entity in FIG. 2, platform 100 may reside on the plurality of nodes and may be distributed with multiple points of access. Since all the information is stored on the synced blockchain, the data available on all instances will be identical.

### Detailed Description of Exemplary Aspects

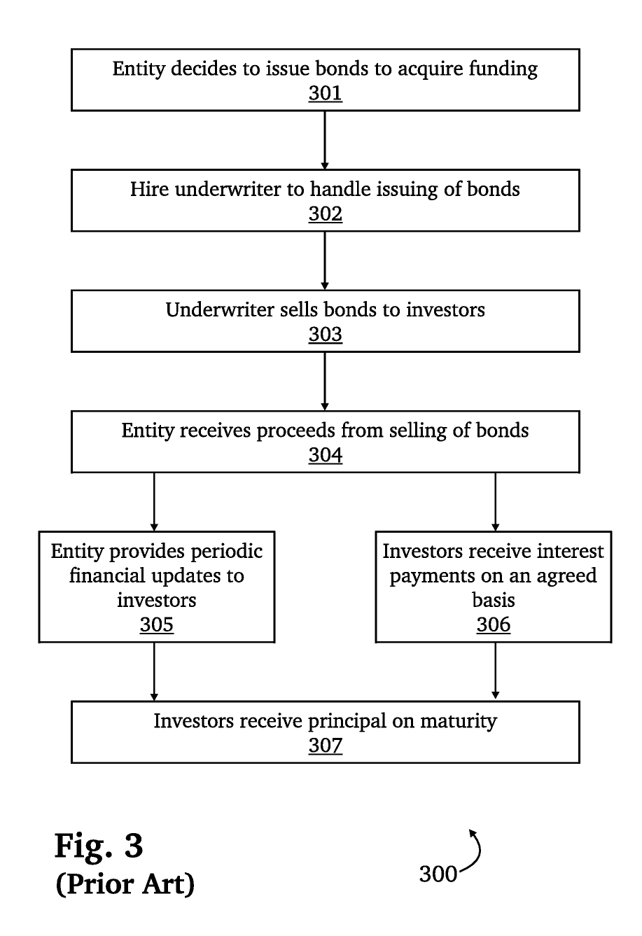

FIG. 3 (Prior Art) is a flow diagram illustrating an exemplary method 300 for issuing bonds in the prior art. At an initial step 301, an entity decides that it needs additional financial resources to fund a particular project or venture. The entity may be, for example, a company, municipal government, or the like. At step 302, the entity hires an underwriter, generally an investment banker, to handle the issuing of bonds. This generally involves the underwriting deciding on pricing, handling regulatory issues, filing paperwork, and the like. At step 303, once bonds are ready to be sold, the underwriter sells bonds to investors. This is generally accompanied by an official statement to investors by the entity. At step 304, as bonds are sold, the proceeds go to the entity. At step 305, throughout the lifetime of the bond, the entity may provide investors periodic updates regarding the financial situation and health of the company. At step 306, investors may receive coupon payments at a rate and frequency that was decided at the time of issuance, for example, this may be 5% interest, paid semiannually, over 2 years. At step 307, the investor receives the principal back at once the bond matures. Using the example from step 306, the bond matures after the predesignated 2 year period.

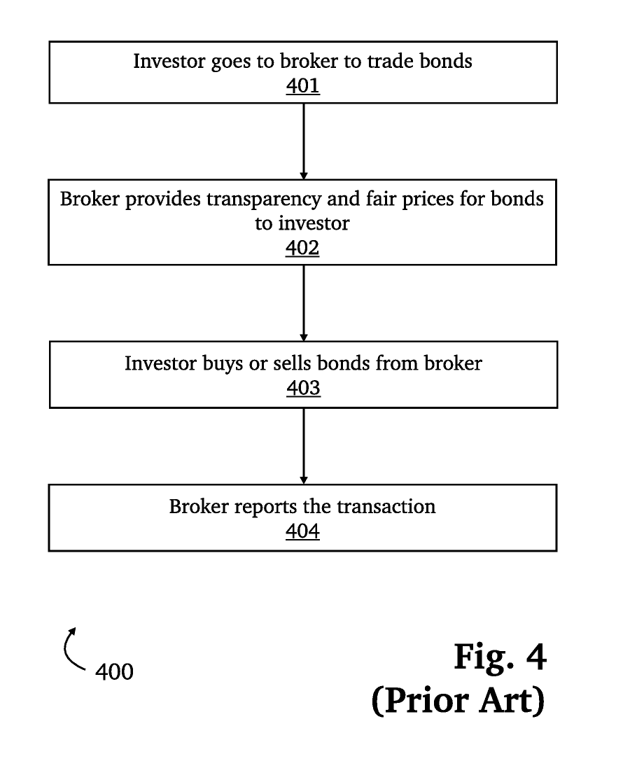

FIG. 4 (Prior Art) is a flow diagram illustrating an exemplary method 400 for bond trading in a secondary market in the prior art. At an initial step 401, an investor goes to a broker to buy or sell bonds. In the art, bonds are typically traded in an over-the-counter (OTC) market, unlike stocks, due to the variety of bonds. For example, bonds from a particular company issued at different times may carry different face values, yield, term length, and the like. At step 402, the broker provides transparency and fair prices for listed bonds. At step 403, the investor makes a transaction for one or more bonds with the broker. At step 404, the broker reports the transfer with applicable regulatory bodies. OTC markets may be typically less regulated than, for example, a stock exchange such as the New York Stock Exchange. Due to these less stringent regulations, in some instances, OTC markets may have transactions made between two participating parties without disclosing the pricing of the trade to other participants, therefore making these OTC markets less transparent. It should be appreciated by one skilled in the art that method 400 may also be applied to other commodities traded through brokers and OTC markets, and is not limited to just transactions involving bonds.

Through the use of platform 100, an issuer may issue bonds directly to the public. Involvement of the underwriter may be optional, and bond issuance may be automatically recorded on the blockchain. Bonds may also be easily traded via marketplace 125, without involving any brokers.

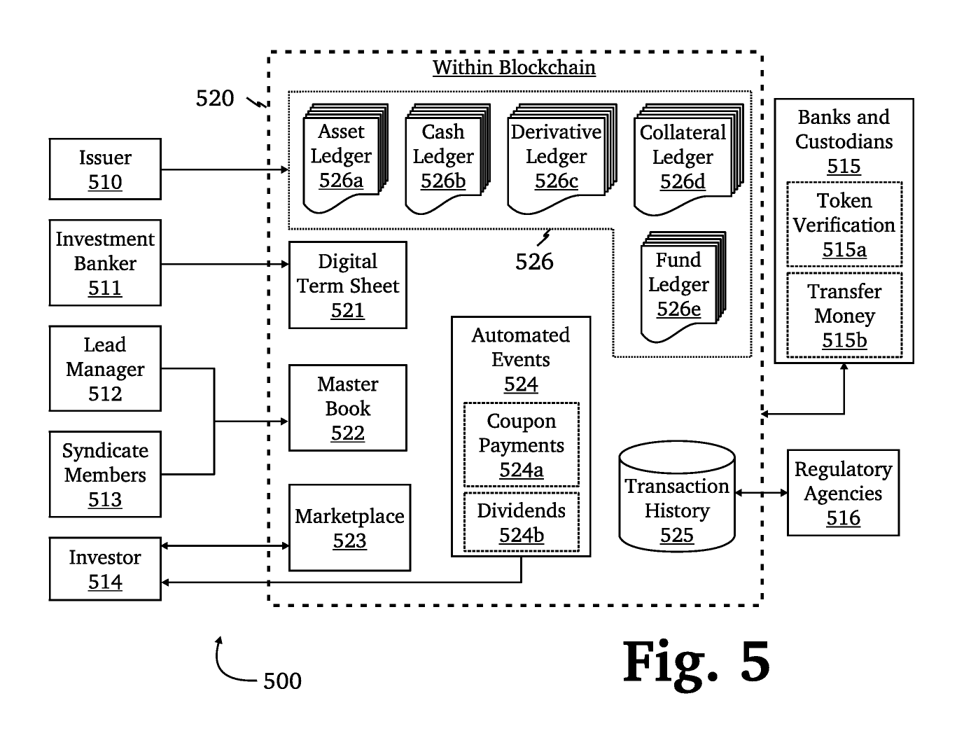

FIG. 5 is a block diagram of an exemplary system 500 showing a typical layout and involvement of various entities in bond issuance according to various embodiments of the invention. System 500 may comprise an issuer 510, an investment banker 511, a lead manager 512, a plurality of syndicate members 513, a plurality of investors 514, a plurality of banks and custodians 515, a plurality of regulatory agencies 516, and a blockchain 520. Issuer 510 may be, for example, a company, a government agency, a municipal government, and the like. Issuer 510 may disclose, as part of a registration process, a plurality of assets 526. Assets 526, for example, may include recorded in an asset ledger 526a, a cash ledger 526b, a derivative ledger 526c, a collateral ledger 526d, a fund ledger 526e, and the like. This may provide transparency to potential investors, and allow investors to determine risks associated with investing in issuer 510.

Investment banker 511, which may be optional, may be hired by issuer 510 to manage bond issuance, and handle other related duties involved with issuing bonds as is currently in the art. This may include, for example, pricing capital, providing financial advice, dealing with regulatory issues, drafting a term sheet (which may be transferred to blockchain 520 and be compiled into a digital term sheet 521), marketing bonds to potential investors, and the like. Digital term sheet 521 may be used by platform 100 to generate smart contracts.

Lead manager 512 and syndicate members 513 may be counterparties involved in holding some of the bonds issued by issuer 510, as is common in the art. A master book 522 may be stored on blockchain 520 which may list all counterparties involved.

Investors 514 may be users of the general public who may have located an investment opportunity using the marketplace interface of platform 100. Investors may conduct trades (including buying, selling, or direct trade with other users) of bonds through a marketplace 523 stored on and operating from blockchain 520. For investors which are bondholders, a plurality of automated events 524 may be executed according to smart contracts compiled from digital term sheet 521, which are discussed above in FIG. 1, and examples provided below. Automated events 524 may include, for example, automated coupon payments 524a and automated distribution of dividends 524b.

Banks and custodians 515 may be financial institutions associated with all involved parties. For example, custodians may be in charge of management the assets of issuer 510 outside of the blockchain, and banks may be institutions in which participants may hold accounts and be in charge of the transfer of money 515b. Banks and custodians 515 may also be responsible for verifying tokens 515a which may be created and transferred using platform 100.

Regulatory agencies 516 may be any agency that oversees a particular industry. In this example, an involved regulatory agency may be the United States Securities and Exchange Commission, which oversees and regulates financial markets in the United States. Since transaction history 525 are automatically recorded to the blockchain, regulatory agencies 516 may monitor the blockchain for any misconduct, and may act to carry out corrective measures to protect involved parties.

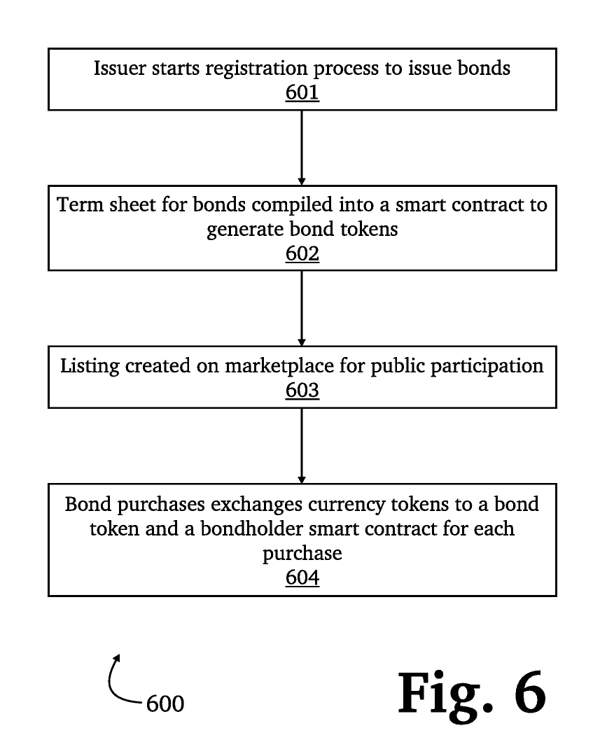

FIG. 6 is a flow diagram illustrating an exemplary method 600 for an issuer issuing bonds with platform 100 according to various embodiments of the invention. At an initial step 601, an issuer may initiate a request to issue bonds with registration service 135. An issuer may be, for example, a company, a government agency, municipal governments, and the like that may be in need of monetary resources to fund a project or business venture. At step 602, platform 100 generates a bond-issuing smart contract to generate bond tokens for potential bond purchasers in exchange for a predetermine number of IRIS tokens, to signify ownership of the bond-issuing smart contract. This may involve, for example, the issuer accessing a smart contract generation front-end, and inputting contractual terms for bondholders or providing a formatted term sheet. The bond issuing smart contract may also contain operations to take in such cases as the issuer being acquired, the issuer declaring bankruptcy, the issuer defaults, and the like which may involve requiring the issuer to liquidate assets and the proceeds are then distributed to bondholders. Transfer of the debt may also be possible with a transfer of the ownership token, which may be regulated to prevent misconduct. At step 603, a listing for the bonds may be created on the marketplace and opened to public participation. At step 604, a bond token and associated bondholder smart contract may be generated by the issuing smart contract for each bond purchase made by a buyer. The bondholder smart contract may automatically transfer funds from the issuer to the bondholder at a frequency prespecified by the terms set forth by the issuer. The token may be used to signify ownership of an associated bondholder smart contract, and may be traded between users using the marketplace.

Since bond issuing and coupon payments may be automated using smart contracts with platform 100, it will be appreciated by one skilled in the art that this may make it possible to issue a large number of smaller bonds, which may make purchasing and investing in bonds more accessible to the general public. The automated nature may also make it feasible to issue, for example, bonds for smaller scale projects, such as road repairs within a certain neighborhood. In some embodiments, bonds may not be limited to being issued with the same face value, and may be variable based on any amount a particular investor is willing to put in.

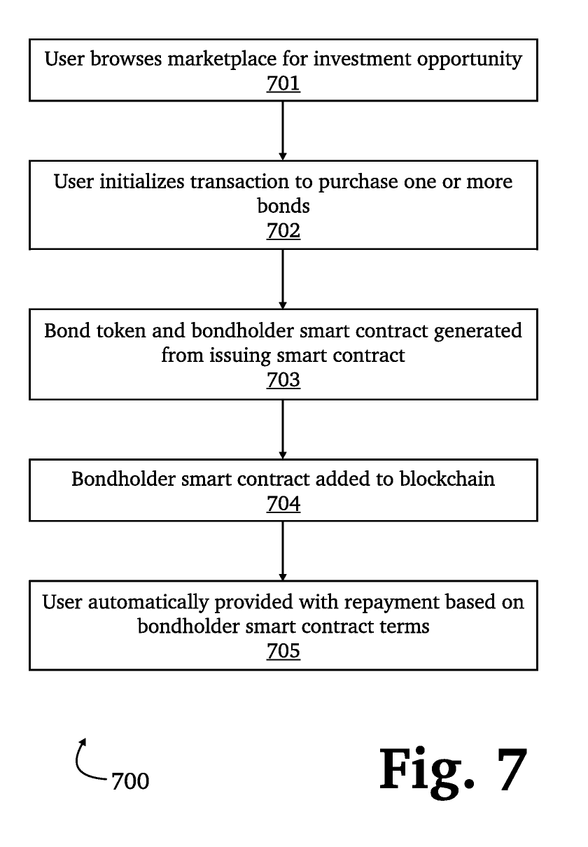

FIG. 7 is a flow diagram illustrating an exemplary method 700 for a bond purchase transaction according to various embodiments of the invention. At an initial step 701, a user may browse the marketplace for an investment opportunity involving bonds. Investment opportunities may include, for example, bonds posted by government agencies, local governments, small and large businesses, and the like which may be have been created using a method like the method discussed in FIG. 6. At step 702, after finding a desirable opportunity, the user may initiate a transaction to exchange currency tokens for a bond. At step 703, a bond token and associated bondholder smart contract may be generated by an issuing smart contract for each bond purchasing transaction made by the user. The bond-ownership smart contract may contain contractual terms for bondholders, for example, interest rates, repayment frequency, time span for maturity, and the like. See FIG. 6 for an example of how an issuing may be created. At step 704, the generated bondholder smart contract is appended to the blockchain. At step 705, the user automatically receives repayment based on the terms of the original investment contract, which are now reproduced in the smart contract.

For the methods illustrated in FIGS. 6 and 7, ownership of a bond may be established by holding the generated bond token, which may be traded by the user with other users via the marketplace. In other embodiments, instead of a using a bond token to specify ownership, the ownership may be specified directly in the bondholder smart contract. Once a trade of the bondholder smart contract is made, the present owner may initiate an ownership transfer provision in the bondholder smart contract to generate a new bondholder smart contract for the next owner. In addition to bonds, an issuer may have a contract for goods that may be accepted by a user, or organization to fulfill. This may include contracts for food that a caterer may accept, energy contract that an energy company may accept, and the like. In these instances, deliverables may be tracked by registering the deliverables with platform 100, and automatic payment may occur once the contract has been fulfilled.

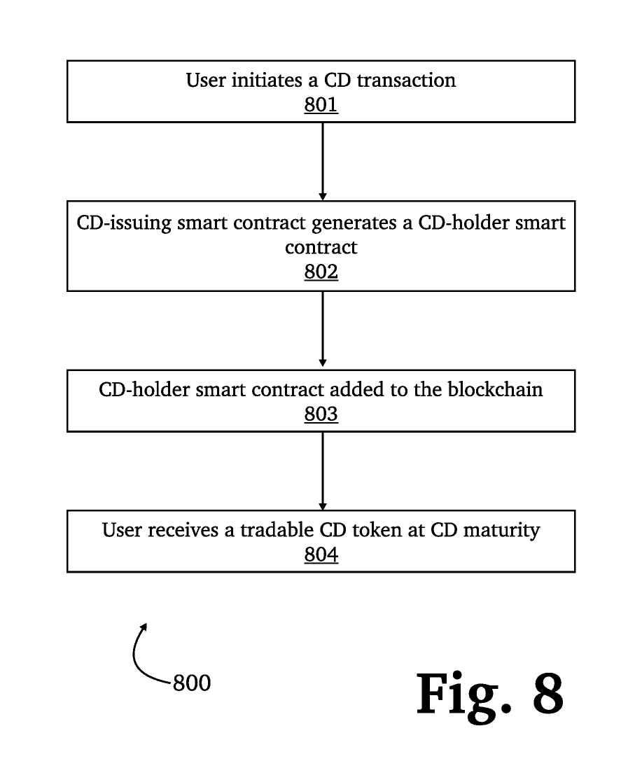

Another type of security that may be issued through platform 100, are bank-issued certificate of deposits. FIG. 8 is a flow diagram illustrating an exemplary method 800 for exchanging currency tokens for a bank-issued certificate of deposits according to various embodiments of the invention. At an initial step 801, a user may initiate a transaction to exchange currency tokens for a Certificate of Deposit (CD). CD's may be issued by a bank-created CD-issuing smart contract, and placed on the marketplace. The process of creating a CD-issuing smart contract may be similar to creating a bond-issuing smart contract discussed in FIG. 6. At step 802, the CD, along with contractual terms of said CD, is compiled into a CD-holder smart contract and an untradeable CD token for the user. The CD-holder smart contract may specify, for example, time-based obligations, interest rates, penalty terms and fees, term length, and the like. At step 803, the CD-holder smart contract is added to the blockchain. At step 804, on maturity of the CD, the CD token may be made tradeable by the smart contract, or redeemed for the originally deposited amount plus any interest earned. An intuitive method may be used to easily differentiate between different types of tokens on the user interface of a user's wallet, for example, CD tokens may have different colors to represent different status. For instance, a silver token may represent an immature token which has not reached maturity and still may be collecting interest payments. A purple token may be a token which has matured, and is treated by the interface as cash for the purposes of purchasing other debt instruments. A silver token, being an immature asset which may collect future payments, when traded, will have those future payments collected by the new owner of the token.

In some embodiments, the CD-holder smart contract may comprise a clause for early withdraw, for example, a penalty fee may be automatically deducted from the CD holder. Using platform 100, it may be possible to issue CD's that may reach maturity within 24 hours. This may serve, for example, as a fast way for users to create a tradable store of value that may be used to purchase goods or services within industries that may face federal restrictions which prevent companies in said industries to deal with traditional banking systems.

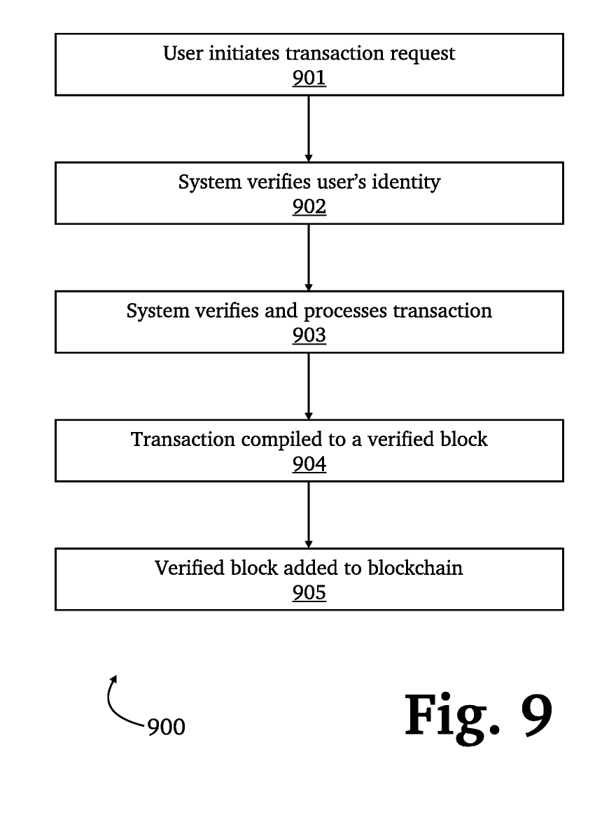

FIG. 9 is a flow diagram illustrating an exemplary method 900 for a general transaction according to various embodiments of the invention. At an initial step 901, a user initiates a transaction request. This may include, for example, registering an asset, issuing bonds, buying or selling of goods and services, exchanging fiat for currency tokens, and the like. More specific examples of transactions are discussed below. At step 902, the user is verified by platform 100 via verification service 110. At step 903, platform 100 verifies the transaction using settlement engine 130, and the transaction may be processed by settlement engine 130 once verified. At step 904, the transaction is compiled into a verified block by platform 100. This may include, for example, generating a smart contract with smart contract generator 120, recording and archiving a transaction, and the like. At step 905, the verified block may be added to the blockchain. In some embodiments, blocks may be encrypted, for example using a blockchain security layer to encrypt data such as ENIGMA which is being developed at the Massachusetts Institute of Technology, so that only certain parties may discern the contents of the block. This may be useful, for example, for making and storing transactions that may contain sensitive information such as a social security number, medical records, banking information, and the like.

It should be understood that although the example in FIG. 9 and other examples shown herein add verified transactions to a blockchain as they are created, typically in the art a block in a blockchain may be a fixed size and may contain a plurality of verified transactions in a single block. For simplicity, these examples will omit the mention of combining of multiple transactions into a single block, but it should not be considered a limitation imposed by the present invention.

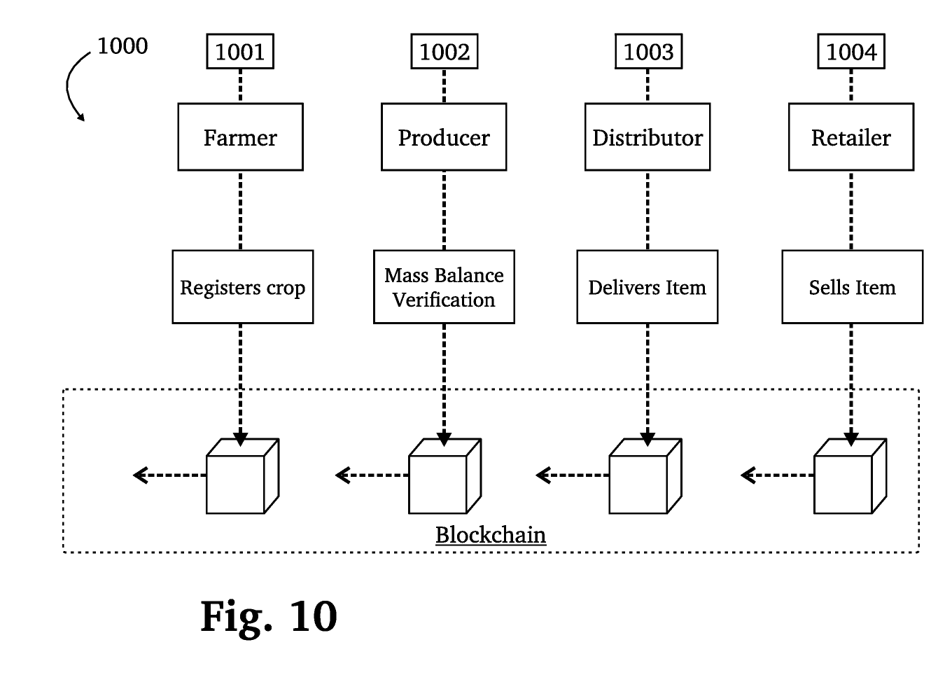

FIG. 10 is a flow diagram illustrating an exemplary method 1000 for production tracking according to various embodiments of the invention. In some industries, it may be required by law to separate sectors in a production chain, for example, in the tobacco industry or alcohol industry in some jurisdictions require that a producer must be separate from the distributor which must be separate from the retailer. Using platform 100, the entire production cycle may be passively and recorded into a blockchain in chronological order as a standard part of the process, and which may not be alterable down the line. At an initial step 1001, a farmer registers their crop using platform 100. The registration generates a token for the crop, and the registration is compiled into a block and added to a blockchain. At step 1002, once the crop has been harvested, the farmer may transfer the crop and the token for the crop to a producer. The producer may perform mass balance verification on the delivered crops, and may then prepare the crops into a product to put to market. The transfer of the token may provide a transparent record that the crop has been harvested and delivered, along with a date, all of which may be recorded on the blockchain. The mass balance verification outcome may also be recorded to the blockchain. At step 1003, after production has finished, the producer ships the product to distributors, who may then distribute the product to retailers, which may also involve the transfer of the token to the distributor which is recorded on the blockchain. At step 1004, the retailer sells the product. The origins of the product may then be back-traced by, for example, including a barcode on the packaging that any interested parties may scan and be shown the records stored on the blockchain. It should be appreciated that the tracking involved in every step of the process from farm to consumer may be useful in some industries with stricter regulations when it comes to production and distribution. Examples of industries that this process may benefit includes the cannabis industry, tobacco industry, and alcohol industry.

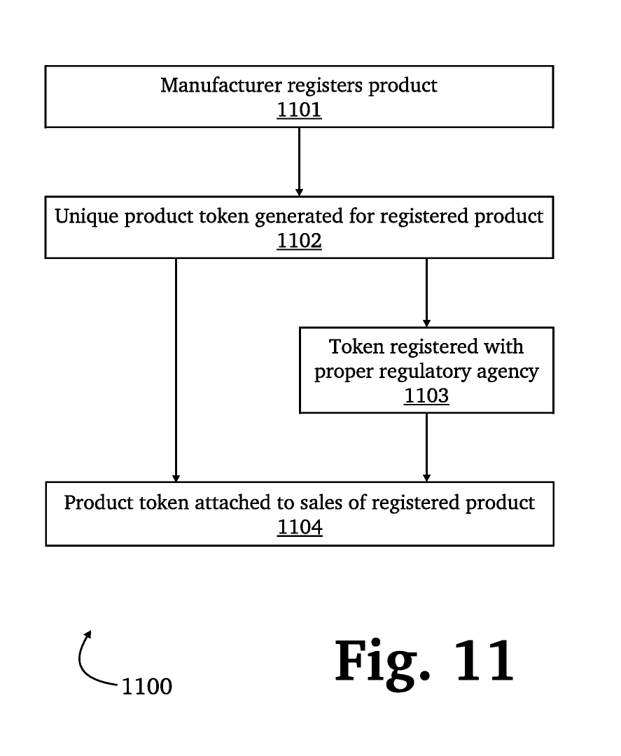

FIG. 11 is a flow diagram illustrating an exemplary method 1100 for a manufacturer registering a product using platform 100 according to various embodiments of the invention. At an initial step 1101, a manufacturer registers a product using registration service 135. At step 1102, a unique product token may be generated and associated with the product by platform 100. At an optional step 1103, if required, the generated token may be registered with an appropriate regulatory agency which oversees production and usage of the product, similar to how a vehicle is assigned a vehicle identification number (VIN) during manufacturing, which is then registered to the United States Department of Transportation. At step 1104, the product token is attached to the sales of the product.

To provide an example, a car manufacturer may register a completed shipment of cars. For each car, a unique car token may be generated and associated to each car. Since all manufactured vehicles in the are required to have a VIN registered to a regulatory agency, the tokens for each car may be registered with the agency as well. The tokens may be used alongside the VIN for tracking the history of the car, similar to the system used today; however, with the tokens and blockchain technology, the information may be readily available for viewing. Finally, the token for each car is attached to the sale of each token's associated car, so that the holder of the token may be signified as the owner for the associated car.

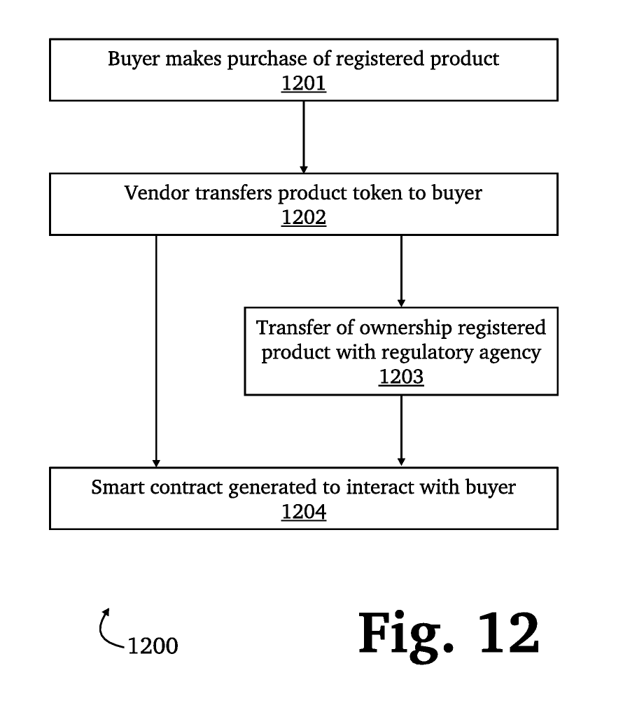

FIG. 12 is a flow diagram illustrating an exemplary method 1200 for transferring a product token using platform 100 according to various embodiments of the invention. At an initial step 1201, a buyer makes a purchase of a product registered with platform 100. At step 1202, the vendor transfers ownership of the product to the buyer, along with a product token previously generated for the product. At an optional step 1203, if required, the transfer of ownership may be registered with a proper regulatory agency. Using the car example used in FIG. 11, the transfer of ownership may be registered with the Department of Motor Vehicles (DMV) in the state in which the transfer of ownership takes place, much like how a buyer files papers with the DMV when purchasing a new vehicle at a dealership. At step 1204, a smart contract may be generated to interact with the buyer, who is the present token holder for the product. The smart contract may be configured to, for example, automatically deducts an annual registration fee for a registered vehicle, automatic payment of property taxes for a home registered with platform 100, and the like. Subsequent transfers of ownership may take place with the transfer of the product token, and the smart contract may be configured to generate a new smart contract in the event that ownership changes.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

Referring now to FIG. 13, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 13 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

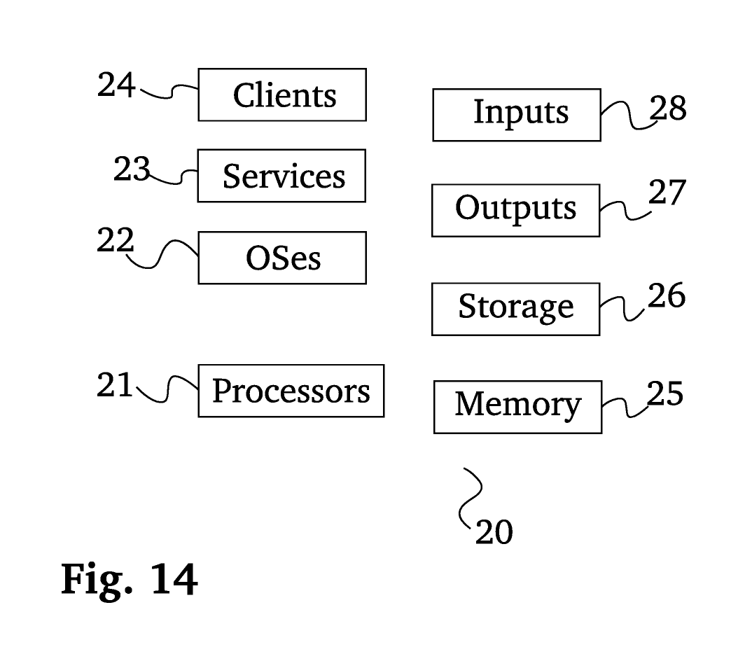

In some aspects, systems may be implemented on a standalone computing system. Referring now to FIG. 14, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 13). Examples of storage devices 26 include flash memory, magnetic hard drive, CD-ROM, and/or the like.

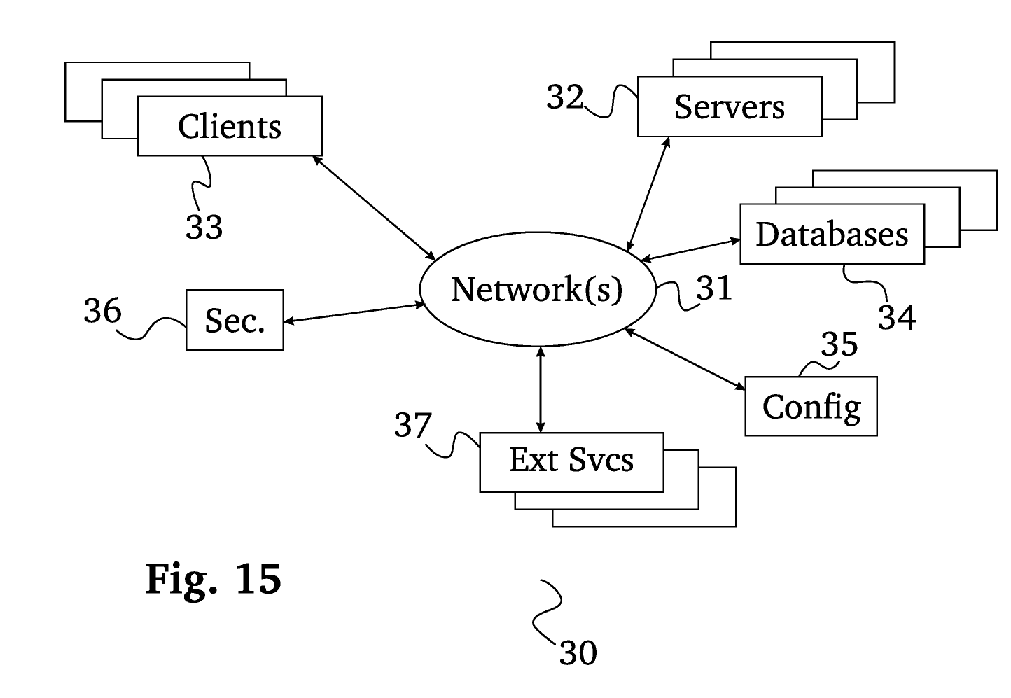

In some aspects, systems may be implemented on a distributed computing network, such as one having any number of clients and/or servers. Referring now to FIG. 15, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 14. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

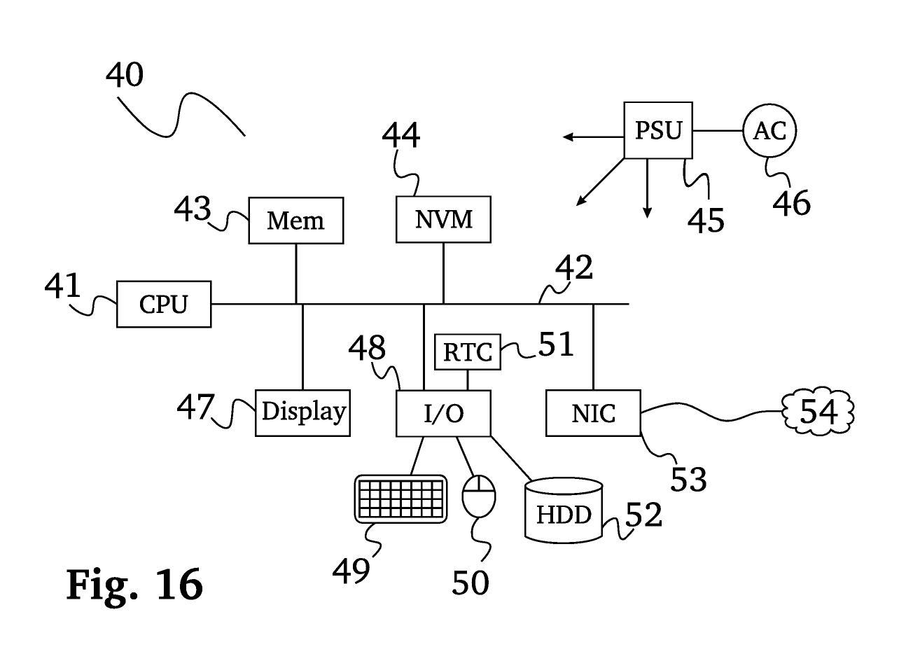

FIG. 16 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

1. A system for blockchain-based asset and immutable real-time intelligent securities management, comprising:
a registration service comprising a memory, a processor, and a plurality of programming instructions stored in the memory thereof and operable on the processor thereof, wherein the programmable instructions, when operating on the processor, cause the at least one processor to:
provide an interface for a user to register a commodity and input additional information pertaining to the commodity including at least a category for the commodity; and
generate an electronic ownership token associated with at least the commodity;
a smart contract generator comprising a memory, a processor, and a plurality of programming instructions stored in the memory thereof and operable on the processor thereof, wherein the programmable instructions, when operating on the processor, cause the processor to:
generate a smart contract based on at least the commodity, the ownership token, and the additional information, wherein the smart contract automatically executes preprogrammed tasks, including executing transactions, when one or more conditions are met; and
a connector service comprising a memory, a processor, and a plurality of programming instructions stored in the memory thereof and operable on the processor thereof, wherein the programmable instructions, when operating on the processor, cause the processor to:
register the commodity with a regulatory agency based at least on the category for the issuance;
wherein the smart contract, the ownership token and at least a portion of records pertaining to the registering of the commodity are stored and propagated on a blockchain.

2. The system of claim 1, further comprising a user verification service comprising a memory, a processor, and a plurality of programming instructions stored in the memory thereof and operable on the processor thereof, wherein the programmable instructions, when operating on the processor, cause the processor to automatically verify the identity of the user by at least using a “know your customer” process wherein background information of a user is checked.

3. The system of claim 1, further comprising a settlement engine comprising a memory, a processor, and a plurality of programming instructions stored in the memory thereof and operable on the processor thereof, wherein the programmable instructions, when operating on the processor, cause the processor to monitor the blockchain for a consensus to be reached before executing a user request.

4. The system of claim 1, further comprising a marketplace front-end comprising a memory, a processor, and a plurality of programming instructions stored in the memory thereof and operable on the processor thereof, wherein the programmable instructions, when operating on the processor, cause the processor to provide an interface to facilitate the exchange of goods and services between a plurality of users.

5. The system of claim 1, wherein the registered commodity results in a bond-issuing smart contract, and the additional information further comprises contractual terms for issued bonds.

6. The system of claim 1, wherein the registered commodity results in a certificate-of-deposit-issuing smart contract, and the additional information further comprises contractual terms for issued certificate of deposits.

7. The system of claim 1, wherein the registered commodity is crops.

8. The system of claim 1, wherein the registered commodity is manufactured articles.

9. A method for blockchain-based asset and securities management, comprising the steps of:
(a) providing an interface for a user to register a commodity and input additional information pertaining to the commodity including at least a category for the commodity, using a registration service;
(b) generating an ownership token associated with at least the commodity, using the registration service;
(c) generating a smart contract based on at least the commodity, the ownership token, and the additional information, using a smart contract generator;
(d) registering the commodity with a regulatory agency based at least on the category for the issuance, using a connector service; and
(e) storing at least a portion of records pertaining to the registering of the commodity, the smart contract, and the ownership token are stored and propagated on a blockchain.

10. The method of claim 9, further comprising automatically verifying the identity of the user by at least using a “know your customer” process wherein background information of a user is checked.

11. The method of claim 9, further comprising monitoring the blockchain for a consensus to be reached before executing a user request.

12. The method of claim 9, further comprising providing an interface to facilitate the exchange of goods and services between a plurality of users.

13. The method of claim 9, wherein the registered commodity results in a bond-issuing smart contract, and the additional information further comprises contractual terms for issued bonds.

14. The method of claim 9, wherein the registered commodity results in a certificate-of-deposit-issuing smart contract, and the additional information further comprises contractual terms for issued certificate of deposits.

15. The method of claim 9, wherein the registered commodity is crops.

16. The method of claim 9, wherein the registered commodity is manufactured articles.

17. The system of claim 1 wherein the memory and processor of the registration service is a same memory and a same processor of one or more of: the smart contract generator and the connector service.
